(19) United States
(12) Patent Application Publication
(10) Pub. No.: US 2022/0114086 A1
(43) Pub. Date: Apr. 14, 2022

(54) TECHNIQUES TO EXPAND SYSTEM MEMORY VIA USE OF AVAILABLE DEVICE MEMORY

(71) Applicant: Intel Corporation, Santa Clara, CA (US)

(72) Inventors: Chace A. CLARK, Hillsboro, OR (US); James A. BOYD, Hillsboro, OR (US); Chet R. DOUGLAS, Denver, CO (US); Andrew M. RUDOFF, Boulder, CO (US); Dan J. WILLIAMS, Forest Grove, OR (US)

(21) Appl. No.: 17/560,007

(22) Filed: Dec. 22, 2021

(51) Int. Cl. G06F 12/02

(52) U.S. Cl. CPC G06F 12/023; G06F 2212/1044

(57) ABSTRACT

Examples include techniques to expand system memory via use of available device memory. Circuitry at a device coupled to a host device partitions a portion of memory capacity of a memory configured for use by compute circuitry resident at the device to execute a workload. The partitioned portion of memory capacity is reported to the host device as being available for use as a portion of system memory. An indication from the host device is received if the portion of memory capacity has been identified for use as a first portion of pooled system memory. The circuitry to monitor usage of the memory capacity used by the compute circuitry to execute the workload to decide whether to place a request to the host device to reclaim the memory capacity from the first portion of pooled system memory.

### TECHNICAL FIELD

Examples described herein are related to pooled memory.

### BACKGROUND

Types of computing systems used by creative professionals or personal computer (PC) gamers may include use of devices that include significant amounts of memory. For example, a discreet graphics card may be used by creative professionals or PC gamers that includes a high amount of memory to support image processing by one or more graphics processing units. The memory may include graphics double data rate (GDDR) or other types of DDR memory having a memory capacity of several gigabytes (GB). While high amounts of memory may be needed by creative professionals or PC gamers when performing intensive/specific tasks, such a large amount of device memory may not be needed for a significant amount of operating runtime.

### BRIEF DESCRIPTION OF THE DRAWINGS

FIG. 1 illustrates an example system.

FIG. 2 illustrates another example of the system.

FIG. 3 illustrates an example first process.

FIGS. 4A-B illustrate an example second process.

FIG. 5 illustrates an example first scheme.

FIG. 6 illustrates an example second scheme.

FIG. 7 illustrates an example third scheme.

FIG. 8 illustrates an example fourth scheme

FIG. 9 illustrates an example first logic flow.

FIG. 10 illustrates an example apparatus.

FIG. 11 illustrates an example second logic flow.

FIG. 12 illustrates an example of a storage medium.

FIG. 13 illustrates an example device.

### DETAILED DESCRIPTION

In some example computing systems of today, most add in or discrete graphics or accelerator cards come with multiple GB s of memory capacity for types of memory such as, but not limited to, DDR, GDDR or high bandwidth memory (HBM). This multiple GBs of memory capacity may be dedicated for use by a GPU or accelerator resident on a respective discrete graphics or accelerator card while being utilized, for example, for gaming and artificial intelligence (AI) work (e.g., CUDA, One API, OpenCL). Meanwhile, a computing system may also be configured to support applications such as Microsoft® Office® or multitenancy application work (whether business or creative type workloads+multiple Internet browser tabs). While supporting these applications, the computing system may reach system memory limits yet have significant memory capacity on discrete graphics or accelerator cards that may not be utilized. If the memory capacity on discrete graphics or accelerator cards were available for sharing at least a portion of that device memory capacity for use as system memory, performance of workloads associated with supporting the application could be improved and provide a better user experience while balancing overall memory needs of the computing system.

In some memory systems, a unified memory access (UMA) may be a type of shared memory architecture deployed for sharing memory capacity for executing graphics or accelerator workloads. UMA may enable a GPU or accelerator to retain a portion of system memory for graphics or accelerator specific workloads. However, UMA does not typically ever relinquish that portion of system memory back for general use as system memory. Use of the shared system memory becomes a fixed cost to support. Further, dedicated GPU or accelerator memory capacities may not be seen by a host computing device as ever being available for use as system memory in an UMA memory architecture.

A new technical specification by the Compute Express Link (CXL) Consortium is the Compute Express Link Specification, Rev. 2.0, Ver. 1.0, published Oct. 26, 2020, hereinafter referred to as “the CXL specification”. The CXL specification introduced the on-lining and off-lining of memory attached to a host computing device (e.g., a server) through one or more devices configured to operate in accordance with the CXL specification (e.g., a GPU device or an accelerator device), hereinafter referred to as a “CXL devices”. The on-lining and off-lining of memory attached to the host computing device through one or more CXL devices is typically for, but not limited to, the purpose of memory pooling of the memory resource between the CXL devices and the host computing device for use as system memory (e.g., host controlled memory). However, a process of exposing physical memory address ranges for memory pooling and from removing these physical memory addresses from the memory pool is done by logic and/or features external to a given CXL device (e.g., a CXL switch fabric manager at the host computing device). In order to better enable a dynamic sharing of a CXL device's memory capacity based on a device's need or lack of need of that memory capacity may require internal, at the device, logic and/or features to decide whether to expose or remove physical memory addresses from the memory pool. It is with respect to these challenges that the examples described herein are needed.

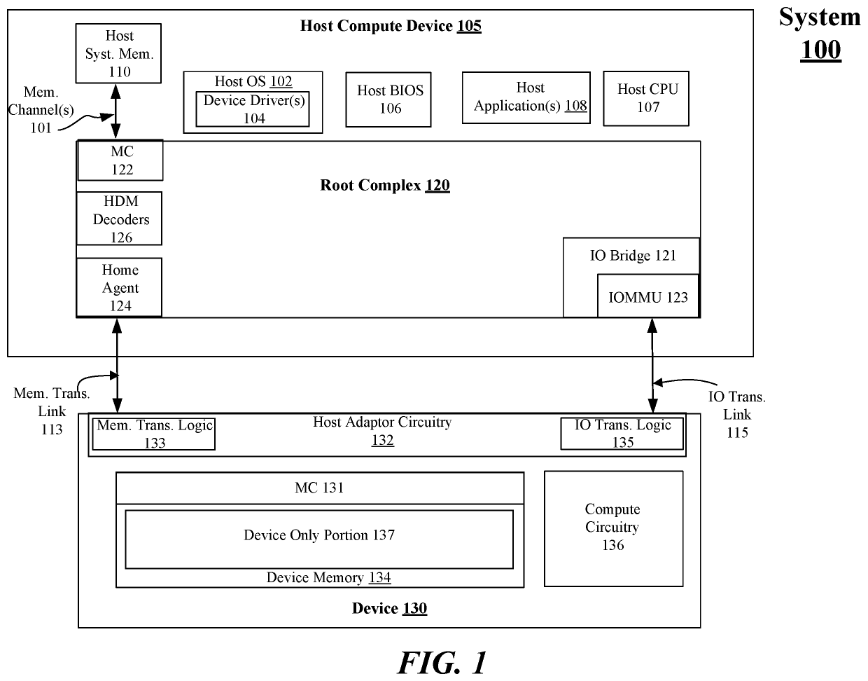

FIG. 1 illustrates an example system 100. In some examples, as shown in FIG. 1, system 100 includes host compute device 105 that has a root complex 120 to couple with a device 130 via at least a memory transaction link 113 and an input/output IO transaction link 115. Host compute device 105, as shown in FIG. 1 also couples with a host system memory 110 via one or more memory channel(s) 101. For these examples, host compute device 105 includes a host operating system (OS) 102 to execute or support one or more device driver(s) 104, a host basic input/output system (BIOS) 106, one or more host application(s) 108 and a host central processing unit (CPU) 107 to support compute operations of host compute device 105.

In some examples, although shown in FIG. 1 as being separate from host CPU 107, root complex 120 may be integrated with host CPU 107 in other examples. For either example, root complex 120 may be arranged to function as a type of peripheral component interface express (PCIe) root complex for CPU 107 and/or other elements of host computing device 105 to communicate with devices such as device 130 via use of PCIe-based communication protocols and communication links.

According to some examples, root complex 120 may also be configured to operate in accordance with the CXL specification and as shown in FIG. 1, includes an IO bridge 121 that includes an IO memory management unit (IOMMU) 123 to facilitate communications with device 130 via IO transaction link 115 and includes a home agent 124 to facilitate communications with device 130 via memory transaction link 113. For these examples, memory transaction link 113 may operate similar to a CXL.mem transaction link and IO transaction link 115 may operate similar to a CXL.io transaction link. As shown in FIG. 1 and described more below, root complex 120 includes host-managed device memory (HDM) decoders 126 that may be programmed to facilitate a mapping of host to device physical addresses for use in system memory (e.g., pooled system memory). A memory controller (MC) 122 at root complex 120 may control/manage access to host system memory 110 through memory channel(s) 101. Host system memory 110 may include volatile and/or non-volatile types of memory. In some examples, host system memory 110 may include one or more dual in-line memory modules (DIMMs) that may include any combination of volatile or non-volatile memory. For these examples, memory channel(s) 101 and host system memory 110 may operate in compliance with a number of memory technologies described in various standards or specifications, such as DDR3 (DDR version 3), originally released by JEDEC (Joint Electronic Device Engineering Council) on Jun. 27, 2007, DDR4 (DDR version 4), originally published in September 2012, DDR5 (DDR version 5), originally published in July 2020, LPDDR3 (Low Power DDR version 3), JESD209-3B, originally published in August 2013, LPDDR4 (LPDDR version 4), JESD209-4, originally published by in August 2014, LPDDR5 (LPDDR version 5, JESD209-5A, originally published by in January 2020), WIO2 (Wide Input/output version 2), JESD229-2 originally published in August 2014, HBM (High Bandwidth Memory), JESD235, originally published in October 2013, HBM2 (HBM version 2), JESD235C, originally published in January 2020, or HBM3 (HBM version 3), currently in discussion by JEDEC, or others or combinations of memory technologies, and technologies based on derivatives or extensions of such specifications. The JEDEC standards or specifications are available at www.jedec.org.

In some examples, as shown in FIG. 1, device 130 includes host adaptor circuitry 132, a device memory 134 and a compute circuitry 135. Host adaptor circuitry 132 may include a memory transaction logic 133 to facilitate communications with elements of root complex 120 (e.g., home agent 124) via memory transaction link 113. Host adaptor circuitry 132 may also include an IO transaction logic 135 to facilitate communications with elements of root complex 120 (e.g., IOMMU 123) via IO transaction link 115. Host adaptor circuitry 132, in some examples, may be integrated (e.g., same chip or die) with or separate from compute circuitry 136 (separate chip or die). Host adaptor circuitry 132 may be a separate field programmable gate array (FPGA), application specific integrated circuit (ASIC) or general purpose processor (CPU) from compute circuitry 136 or may be executed by a first portion of an FPGA, an ASIC or CPU that includes other portions of the FPGA, the ASIC or CPU to support compute circuitry 136. As described more below, memory transaction logic 133 and IO transaction logic 135 may be included in logic and/or features of device 130 that serve a role in exposing or reclaiming portions of device memory 134 based on what amount of memory capacity is or is not needed by compute circuitry 136 or device 130. The exposed portions of device memory 134, for example, available for use in a pooled or shared system memory that is shared with host compute device 105's host system memory 110 and/or other with other device memory of other device(s) coupled with host compute device 105.

According to some examples, device memory 134 includes a memory controller 131 to control access to physical memory address for types of memory included in device memory 134. The types of memory may include volatile and/or non-volatile types of memory for use by compute circuitry 136 to execute, for example, a workload. For these examples, compute circuitry 136 may be a GPU and the workload may be a graphics processing related workload. In other examples, compute circuitry 136 may be at least part of an FPGA, ASIC or CPU serving as an accelerator and the workload may be offloaded from host compute device 105 for execution by these types of compute circuitry that include an FPGA, ASIC or CPU. As shown in FIG. 1, in some examples, device only portion 137, indicates that all memory capacity included in device memory 134 is currently dedicated for use by compute circuitry 136 and/or other elements of device 130. In other words, current memory usage by device 130 may consume most if not all memory capacity and little to no memory capacity can be exposed or made visible to host computing device 105 for use in system or pooled memory.

As mentioned above, host system memory 110 and device memory 134 may include volatile or non-volatile types of memory. Volatile types of memory may include, but are not limited to, random-access memory (RAM), Dynamic RAM (DRAM), DDR synchronous dynamic RAM (DDR SDRAM), GDDR, HBM, static random-access memory (SRAM), thyristor RAM (T-RAM) or zero-capacitor RAM (Z-RAM). Non-volatile memory may include byte or block addressable types of non-volatile memory having a 3-dimensional (3-D) cross-point memory structure that includes, but is not limited to, chalcogenide phase change material (e.g., chalcogenide glass) hereinafter referred to as “3-D cross-point memory”. Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), anti-ferroelectric memory, resistive memory including a metal oxide base, an oxygen vacancy base and a conductive bridge random access memory (CB-RAM), a spintronic magnetic junction memory, a magnetic tunneling junction (MTJ) memory, a domain wall (DW) and spin orbit transfer (SOT) memory, a thyristor based memory, a magnetoresistive random access memory (MRAM) that incorporates memristor technology, spin transfer torque MRAM (STT-MRAM), or a combination of any of the above.

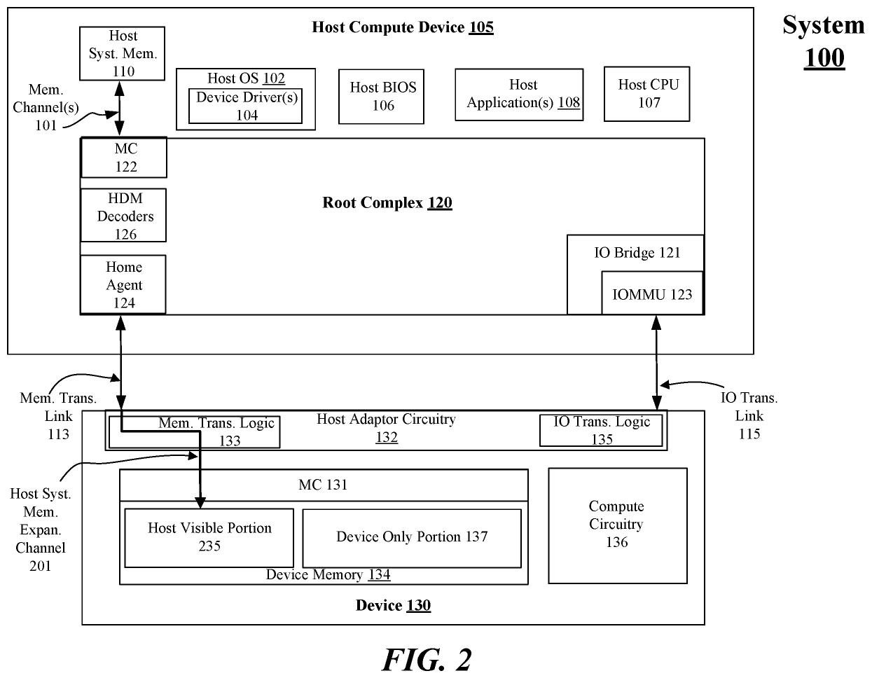

FIG. 2 illustrates another example of system 100. For the other example of system 100 shown in FIG. 2, device 130 is shown has including a host visible portion 235 as well as a device only portion 137. According to some examples, logic and/or features of device 130 may be capable of exposing at least a portion of device memory 134 to make that portion visible to host compute device 105. For these examples, as described more below, logic and/or features of host adaptor circuitry 132 such as IO transaction logic 135 and memory transaction logic 133 may communicate via respective IO transaction link 115 and memory transaction link 113 to open a host system memory expansion channel 201 between device 130 and host compute device 105. Host system memory expansion channel 201 may enable elements of host computing device 105 (e.g., host application(s) 108) to access a host visible portion 235 of device memory 134 as if host visible portion 235 is a part of a system memory pool that also includes host system memory 110.

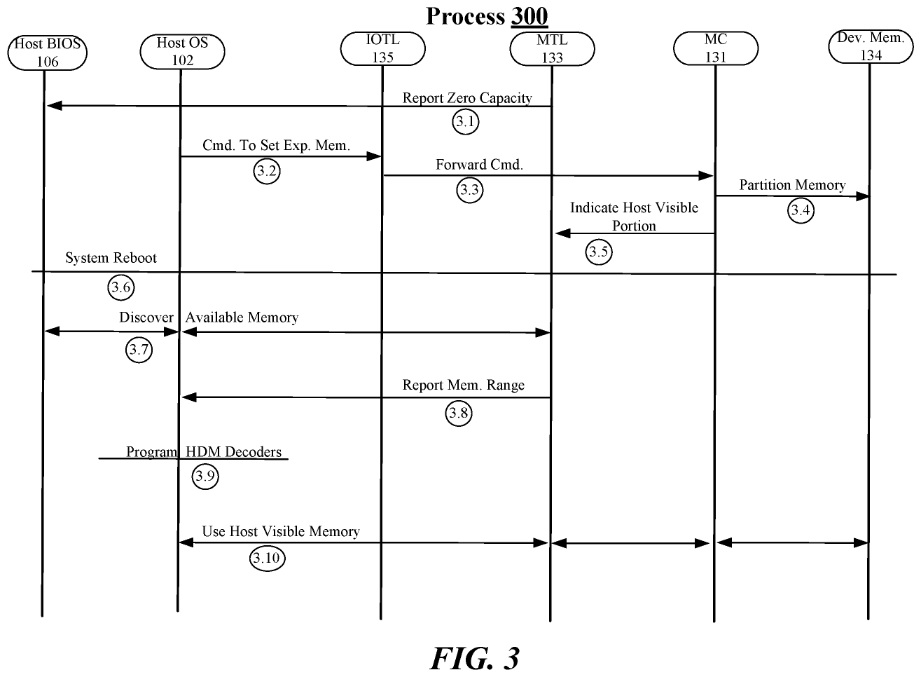

FIG. 3 illustrates an example process 300. According to some examples, process 300 shows an example of a manual static flow to expose a portion of device memory 134 of device 130 to host compute device 105. For these examples, compute device 105 and device 130 may be configured to operate according to the CXL specifications. Examples of exposing device memory are not limited to CXL specification examples. Process 300 may depict an example of where an information technology (IT) manager for a business may want to set a configuration they may wish to support based on usage by employees or users of compute device managed by the IT manager. For these examples, a onetime static setting may be applied to device 130 to expose a portion of device memory 134 and the portion exposed does not change or is changed only if the compute device is rebooted. In other words, the static setting cannot be dynamically changed during runtime of compute device. As shown in FIG. 1, elements of device 130 such as IO transaction logic (IOTL) 135, memory transaction logic (MTL) 133 and memory controller (MC) 131 are described below as being part of process 300 to expose a portion of device memory 134. Also, elements of compute device 105 such as host OS 102 and host BIOS 106 are also a part of process 300. Process 300 is not limited to these elements of device 130 or compute device 105.

Beginning at process 3.1 (Report Zero Capacity), logic and/or features of host adaptor circuitry 132 such as MTL 133 may report zero capacity configured for use as pooled system memory to host BIOS 106 upon initiation or startup of system 100 that includes device 130. However, MTL 133 reports an ability to expose memory capacity (e.g., exposed CXL.mem capacity) by partitioning off some of device memory 134 such as host visible portion 235 shown in FIG. 2. According to some examples, firmware instructions for host BIOS 106 may be responsible for enumerating and configuring system memory and, at least initially, no portion of device memory 134 is to be accounted for as part of system memory. BIOS 106 may relay information to host OS 102 for host OS 102 to later discover this ability to exposed memory capacity.

Moving to process 3.2 (Command to Set Exposed Memory), software of host compute device 105 such as Host OS 102 issues a command to set the portion of device memory 134 that was indicated above as having an ability to be exposed memory capacity to be added to system memory. In some examples, host OS 102 may issue the command to logic and/or features of host adaptor circuitry 132 such as IOTL 135.

Moving to process 3.3 (Forward Command), IOTL 135 forwards the command received from host OS 102 to control logic of device memory 134 such as MC 131.

Moving to process 3.4 (Partition Memory), MC 131 may partition device memory 134 based on the command. According to some examples, MC 131 may create host visible portion 235 responsive to the command.

Moving to process 3.5 (Indicate Host Visible Portion), MC 131 indicates to MTL 133 that host visible portion 235 has been partitioned from device memory 134. In some examples, host visible portion 235 may be indicated by supplying a device physical address (DPA) range that indicates the partitioned physical addresses of device memory 134 included in host visible portion 235.

Moving to process 3.6 (System Reboot), system 100 is rebooted.

Moving to process 3.7 (Discover Available Memory), host BIOS 106 and Host OS 102, as part of enumerating and configuring system memory may be able to utilize CXL.mem protocols to enable MTL 133 to indicate that device memory 134 memory capacity included in host visible portion 235 is available. According to some examples, system 100 may be rebooted to enable the host BIOS 106 and Host OS 102 to discover available memory via enumerating and configuring processes as described in the CXL specification.

Moving to process 3.8 (Report Memory Range), logic and/or features of host adaptor circuitry 132 such as MTL 133 reports the DPA range included in host visible portion 235 to Host OS 102. In some examples, CXL.mem protocols may be used by MTL 133 to report the DPA range.

Moving to process 3.9 (Program HDM Decoders), logic and/or features of host OS 102 may program HDM decoders 126 of compute device 105 to map the DPA range included in host visible portion 235 to a host physical address (HPA) range in order to add the memory capacity of host visible portion 235 to system memory. According to some examples, HDM decoders 126 may include a plurality of programmable registers included in root complex 120 that may be programmed in accordance with the CXL specification to determine which root port is a target of a memory transaction that will access the DPA range included in host visible portion 235 of device memory 134.

Moving to process 3.10 (Use Host Visible Memory), logic and/or features of host OS 102 may use or may allocate at least some memory capacity of host visible portion 235 for use by other types of software. In some examples, the memory capacity may be allocated to one or more applications from among host application(s) 108 for use as system or general purpose memory. Process 300 may then come to an end.

According to some examples, future changes to memory capacity by the IT manager may require a re-issuing of CXL commands by host OS 102 to change the DPA range included in host visible portion 235 to protect an adequate amount of dedicated memory for use by compute circuitry 136 to handle typical workloads. These future changes need not worry about possible non-paged, pinned, or locked pages allocated in the DPA range, as configuration changes will occur only if system 100 is power cycled. CXL commands to change available memory capacities, as an added layer of protection, may also be password protected.

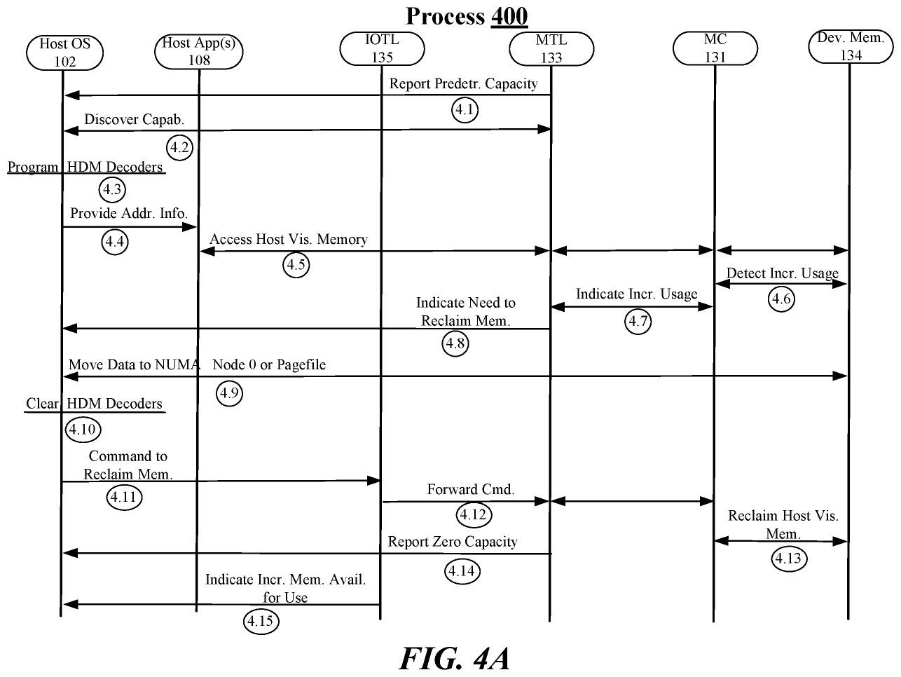

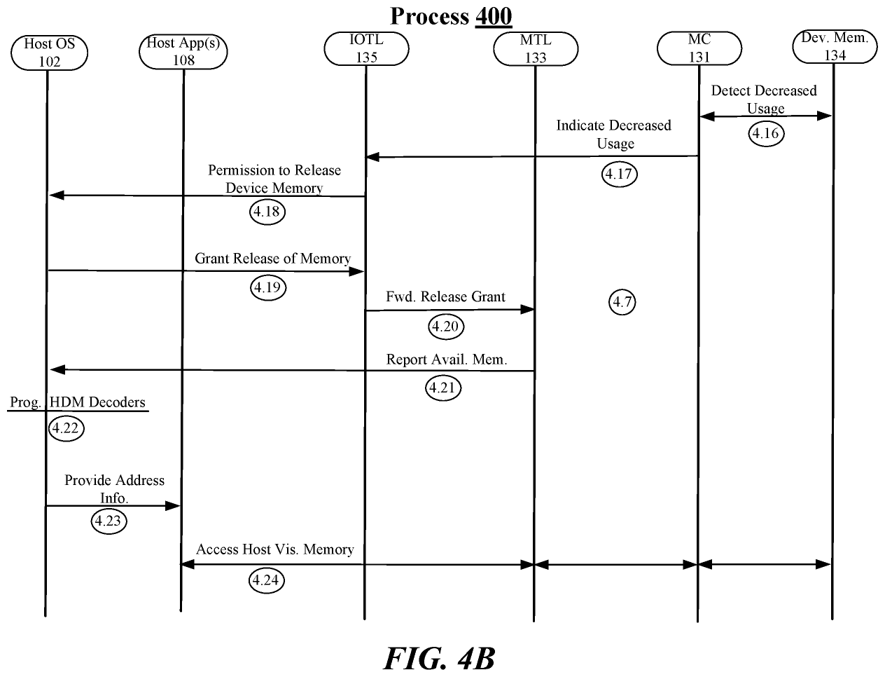

FIGS. 4A-B illustrate an example process 400. In some examples, process 400 shows an example of dynamic flow to expose or reclaim a portion of device memory 134 of device 130 to host compute device 105. For these examples, compute device 105 and device 130 may be configured to operate according to the CXL specification. Examples of exposing or reclaiming device memory are not limited to CXL specification examples. Process 400 depicts dynamic runtime changes to available memory capacity provided by device memory 134. As shown in FIGS. 4A-B, elements of device 130 such as IOTL 135, MTL 133 and MC 131 are described below as being part of process 400 to expose or reclaim at least a portion of device memory 134. Also, elements of compute device 105 such as host OS 102 and host application(s) 108 are also a part of process 400. Process 400 is not limited to these elements of device 130 or of compute device 105.

In some examples, as shown in FIG. 4A, process 400 begins at process 4.1 (Report Predetermined Capacity), logic and/or features of host adaptor circuitry 132 such as MTL 133 reports a predetermined available memory capacity for device memory 134. According to some examples, the predetermined available memory capacity may be memory capacity included in host visible portion 235. In other examples, zero predetermined available memory may be indicated to provide a default to enable device 130 to first operate for a period of time to determine what memory capacity is needed before reporting any available memory capacity.

Moving to process 4.2 (Discover Capabilities), host OS 102 discover capabilities of device memory 134 to provide memory capacity for use in system memory for compute device 105. According to some examples, CXL.mem protocols and/or status registers controlled or maintained by logic and/or features of host adaptor circuitry 132 such as MTL 133 may be utilized by host OS 102 or elements of host OS 102 (e.g., device driver(s) 104) to discover these capabilities. Discovery may include MTL 133 indicating a DPA range that indicates physical addresses of device memory 134 exposed for use in system memory.

Moving to process 4.3 (Program HDM Decoders), logic and/or features of host OS 102 may program HDM decoders 126 of compute device 105 to map the DPA range discovered at process 4.2 to an HPA range in order to add the discovered memory capacity included in the DPA range to system memory. In some examples, while CXL.mem address or DPA range programmed to HDM decoders 126 is usable by host application(s) 108, non-pageable allocations or pinned/locked page allocations of system memory addresses will only be allowed in physical memory addresses of host system memory 110. As described more below, a memory manager of a host OS may implement example schemes to cause physical memory addresses of host system memory 110 and physical memory addresses in the discovered DPA range of device memory 134 to be included in different non-uniform mapping architecture (NUMA) nodes to prevent a kernel or an application from having any non-paged, locked or pinned pages in the NUMA node that includes the DPA range of device memory 134. Keeping non-paged, locked or pinned pages from the NUMA node that includes the DPA range of device memory 134 provides greater flexibility to dynamically resize available memory capacity of device memory as it prevents kernels or applications from restricting or delaying the reclaiming of memory capacity when needed by device 130.

Moving to process 4.4 (Provide Address Information), host OS 102 provides address information for system memory addresses programmed to HDM decoders 126 to application(s) 108.

Moving to process 4.5 (Access Host Visible Memory), application(s) 108 may access the DPA addresses mapped to programmed HDM decoders 125 for the portion of device memory 134 that was exposed for use in system memory. In some examples, applications(s) 108 may route read/write requests through memory transaction link 113 and logic and/or features of host adaptor circuitry 132 such as MTL 133 may forward the read/write requests to MC 131 to access the exposed memory capacity of device memory 134.

Moving to process 4.6 (Detect Increased Usage), logic and/or features of MC 131 may detect increased usage of memory device 134 by compute circuitry 136. According to some examples where compute circuitry 136 is a GPU used for gaming applications, a user of compute device 105 may start playing a graphics-intensive game to cause a need for a large amount of memory capacity of memory device 134.

Moving to process 4.7 (Indicate Increased Usage), MC 131 indicates an increase usage of the memory capacity of memory device 134 to MTL 133.

Moving to process 4.8 (Indicate Need to Reclaim Memory), MTL 133 indicates to host OS 102 a need to reclaim memory that was previously exposed and included in system memory. In some examples, CXL.mem protocols for a hot-remove of the DPA range included in the exposed memory capacity may be used to indicate a need to reclaim memory.

Moving to process 4.9 (Move Data to NUMA Node 0 or Pagefile), host OS 102 causes any data stored in the DPA range included in the exposed memory capacity to be moved to a NUMA node 0 or to a Pagefile maintained in a storage device coupled to host compute device 105 (e.g., a solid state drive). According to some examples, NUMA node 0 may include physical memory addresses mapped to host system memory 110.

Moving to process 4.10 (Clear HDM Decoders), host OS 102 clears HDM decoders 126 programed to the DPA range included in the reclaimed memory capacity to remove that reclaimed memory of memory device 134 from system memory.

Moving to process 4.11 (Command to Reclaim Memory), host OS 102 sends a command to logic and/or features of host adaptor circuitry 132 such as IOTL 135 to indicate that the memory can be reclaimed. In some examples, CXL.io protocols may be used to send the command to IOTL 135 via IO transaction link 115.

Moving to process 4.12 (Forward Command), IOTL 135 forwards the command to logic and/or features of host adaptor circuitry 132 such as MTL 133. MTL 133 takes note of the approval to reclaim the memory and forwards the command to MC 131.

Moving to process 4.13 (Reclaim Host Visible Memory), MC 131 reclaims the memory capacity previously exposed for use for system memory. According to some examples, reclaiming the memory capacity dedicates that reclaimed memory capacity for use by compute circuitry 136 of device 130.

Moving to process 4.14 (Report Zero Capacity), logic and/or features of host adaptor circuitry 132 such as MTL 133 reports to host OS 102 that zero memory capacity is available for use as system memory. In some examples, CXL.mem protocols may be used by MTL 133 to report zero capacity.

Moving to process 4.15 (Indicate Increased Memory Available for Use), logic and/or features of host adaptor circuitry 132 such as IOTL 135 may indicate to host OS 102 that memory dedicated for use by compute circuitry 136 of device 130 is available for use to execute workloads. In some examples where device 130 is a discrete graphics card, the indication may be sent to a GPU driver included in device driver(s) 104 of host OS 102. For these examples, IOTL 135 may use CXL.io protocols to send an interrupt/notification to the GPU driver to indicate that the increased memory is available.

In some examples, as shown in FIG. 4B, process 400 continues at process 4.16 (Detect Decreased Usage), logic and/or features of MC 131 detects a decreased usage of device memory 134 by compute circuitry 136. According to some examples where compute circuitry 136 is a GPU used for gaming applications, a user of compute device 105 may stop playing a graphics-intensive game to cause the detected decreased usage of memory device 134 by compute circuitry 136.

Moving to process 4.17 (Indicate Decreased Usage), MC 131 indicates the decrease in usage to logic and/or features of host adaptor circuitry 132 such as IOTL 135.

Moving to process 4.18 (Permission to Release Device Memory), IOTL 135 sends a request to host OS 102 to release at least a portion of device memory 134 to be exposed for use in system memory. In some examples where device 130 is a discrete graphics card, the request may be sent to a GPU driver included in device driver(s) 104 of host OS 102. For these examples, IOTL 135 may use CXL.io protocols to send an interrupt/notification to the GPU driver to request the release of at least a portion of memory included in memory device 130 that was previously dedicated for use by compute circuitry 136.

Moving to process 4.19 (Grant Release of Memory), host OS 102/device driver(s) 104 indicates to logic and/or features of host adaptor circuitry 132 such as IOTL 135 that a release of the portion of memory included in memory device 130 that was previously dedicated for use by compute circuitry 136 has been granted.

Moving to process 4.20 (Forward Release Grant), IOTL 135 forwards the release grant to MTL 133.

Moving to process 4.21 (Report Available Memory), logic and/or features of host adaptor circuitry 132 such as MTL 133 reports available memory capacity for device memory 134 to host OS 102. In some examples, CXL.mem protocols and/or status registers controlled or maintained by MTL 133 may be used to report available memory to host OS 102 as a DPA range that indicates physical memory addresses of device memory 134 available for use as system memory.

Moving to process 4.22 (Program HDM Decoders), logic and/or features of host OS 102 may program HDM decoders 126 of compute device 105 to map the DPA range indicated in the reporting of available memory at process 4.20. In some examples, a similar process to program HDM decoders 125 as described for process 4.3 may be followed.

Moving to process 4.23 (Provide Address Information), host OS 102 provides address information for system memory addresses programmed to HDM decoders 126 to application(s) 108.

Moving to process 4.24 (Access Host Visible Memory), application(s) 108 may once again be able to access the DPA addresses mapped to programmed HDM decoders 126 for the portion of device memory 134 that was indicated as being available for use in system memory. Process 400 may return to process 4.6 if increased usage is detected or may return to process 4.1 if system 100 is power cycled or rebooted.

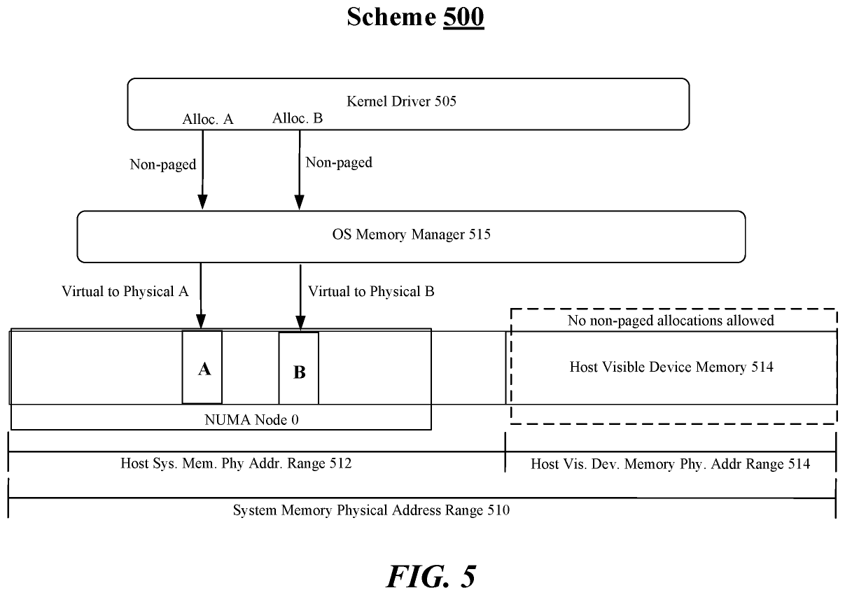

FIG. 5 illustrates an example scheme 500. According to some examples, scheme 500 shown in FIG. 5 depicts how a kernel driver 505 of a compute device may be allocated portions of system memory managed by an OS memory manager 515 that are mapped to a system memory physical address range 510. For these examples, a host visible device memory 514 may have been exposed in a similar manner as described above for process 300 or 400 and added to system memory physical address range 510. Kernel driver 505 may have requested two non-paged allocations of system memory shown in FIG. 5 as allocation A and allocation B. As mentioned above, no non-paged allocations are allowed to host visible device memory to enable a device to more freely reclaim device memory when needed. Thus, as shown in FIG. 5, OS memory manager 515 causes allocation A and allocation B to go to only virtual memory addresses mapped to host system memory physical address range 512. In some examples, a policy may be initiated that causes all non-paged allocations to automatically go to NUMA node 0 and NUMA node 0 to only include host system memory physical address range 512.

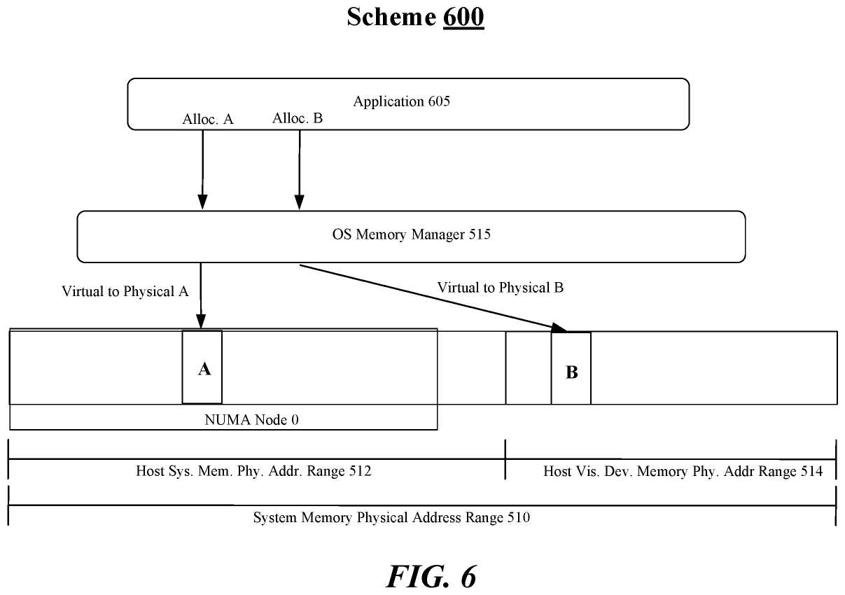

FIG. 6 illustrates an example scheme 600. In some examples, scheme 600 shown in FIG. 6 depicts how an application 605 of a compute device may be allocated portions of system memory managed by OS memory manager 515 that are mapped to system memory physical address range 510. For these examples, application 605 may have placed allocation requests that are shown in FIG. 6 as allocation A and allocation B. Also, for these examples, allocation A and allocation B are not contingent on being non-paged, locked or pinned. Therefore, OS memory manager 515 may be allowed to allocate virtual memory addresses mapped to host visible device physical address range 514 for allocation B.

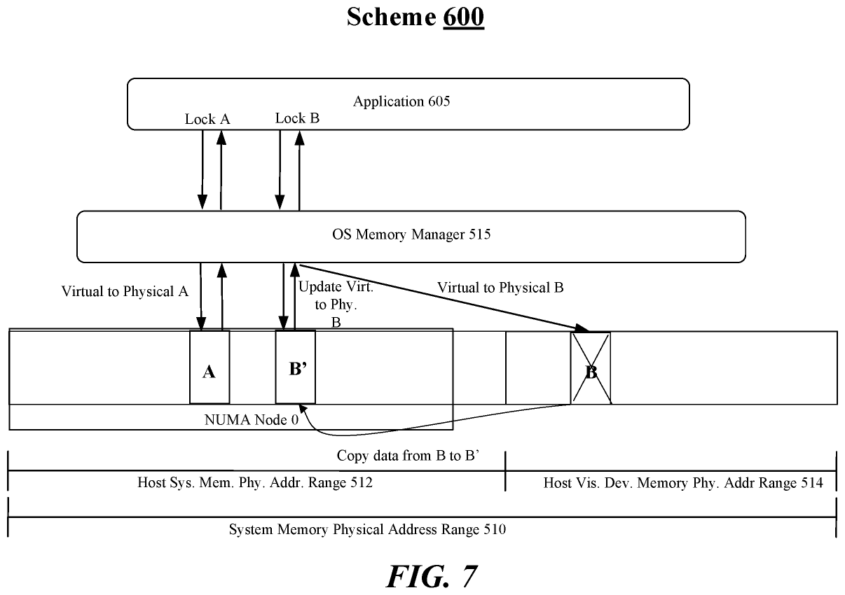

FIG. 7 illustrates an example scheme 700. According to some examples, scheme 700 shown in FIG. 7 depicts how application 605 of a compute device may request that allocations associated with allocation A and allocation B become locked. As mentioned above for scheme 600, allocation B was placed in host visible device memory physical address range 514. As shown in FIG. 7, due to the request to lock allocation B, any data stored to host visible device memory address range 514 needs to be copied to a physical address located in host system memory physical address range 512 and the virtual to physical mapping updated by OS memory manager 515.

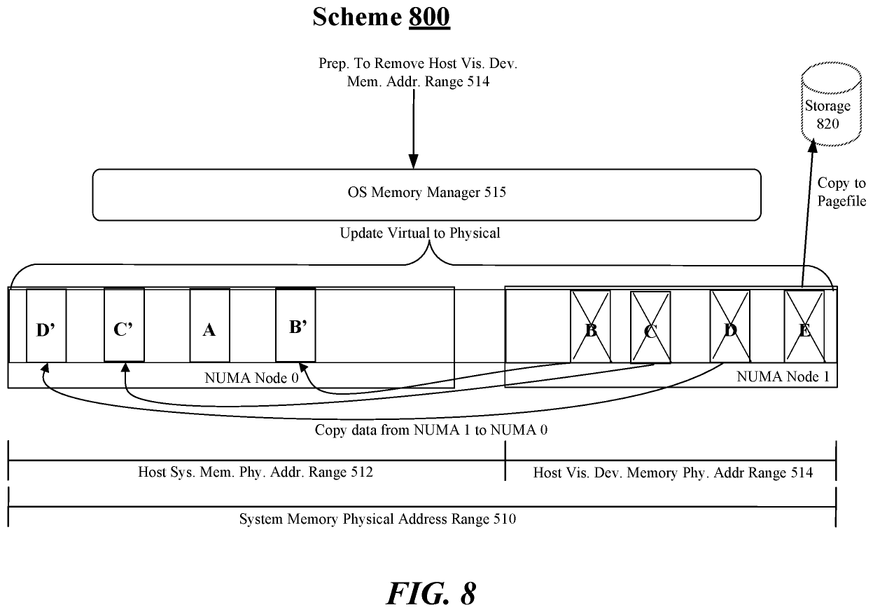

FIG. 8 illustrates an example scheme 800. In some examples, scheme 800 shown in FIG. 8 depicts how OS memory manager 515 prepares for removal of host visible device memory address range 514 from system memory physical address range 510. For these examples, the device that exposed host visible device memory address range 514 may request to reclaim its device memory capacity in a similar manner as described above for process 400. As shown in FIG. 8, host visible device memory physical address range 514 has an assigned affinity to a NUMA node 1 and host system memory physical address range 512 has an assigned affinity to NUMA node 0. As part of the removal process for host visible device memory physical address range 514, OS memory manager 515 may cause all data stored to NUMA node 1 to either be copied to NUMA node 0 or to a storage 820 (e.g., solid state drive or hard disk drive). As shown in FIG. 8, data stored to B, C, and D is copied to B′, C′ and D′ within host system memory physical address range 510 and data stored to E is copy to a Pagefile maintained in storage 820. Following the copying of data from host visible device memory physical address range 514, OS memory manager 515 updates the virtual to physical mapping for these allocations of system memory.

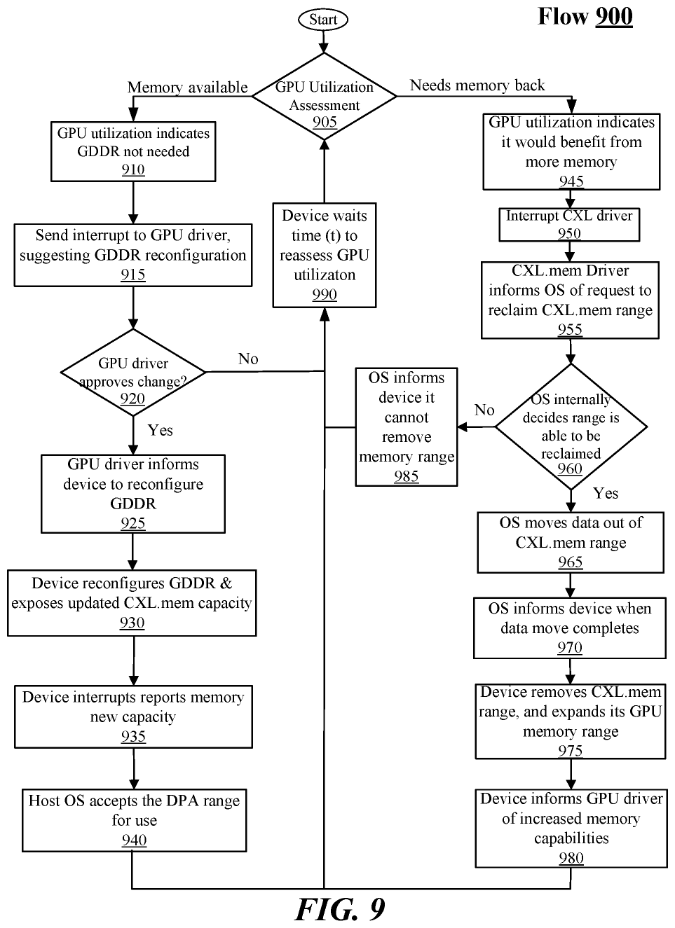

FIG. 9 illustrates an example logic flow 900. In some examples, logic flow 400 may be implemented by logic and/or features of a device that operates in compliance with the CXL specification, e.g., logic and/or features of host adaptor circuitry at the device. For these examples, the device may be a discrete graphics card coupled to a compute device. The discrete graphics card having a GPU that is the primary user of device memory that includes GDDR memory. The host adaptor circuitry, for these examples, may be host adaptor circuitry 132 or device 130 as shown in FIGS. 1-2 for system 100 and compute circuitry 136 may configured as a GPU. Also, device 130 may couple with compute device 105 having a root complex 120, host OS 102, host CPU 107, and host application(s) 108 as shown in FIGS. 1-2 and described above. Host OS 102 may include a GPU driver in driver(s) 104 to communicate with device 130 in relation to exposing or reclaiming portions of memory capacity of device memory 134 controlled by memory controller 131 for use as system memory. Although not specifically mentioned above or below, this disclosure contemplates that other elements of a system similar to system 100 may implement at least portions of logic flow 900.

Logic flow 900 begins at decision block 905 where logic and/or features of device 130 such as memory transaction logic 133 indicates a GPU utilization assessment to determine if memory capacity is available to be exposed for use as system memory or if memory capacity needs to be reclaimed. If memory transaction logic 133 determines memory capacity is available, logic flow moves to block 910. If memory transaction logic 133 determines more memory capacity is needed, logic flow moves to block 945.

Moving from decision block 905 to block 910, GPU utilization indicates that more GDDR capacity is not needed by device 130. According to some examples, GPU utilization of GDDR capacity may be due to a user of compute device 105 not currently running, for example, a gaming application.

Moving from block 910 to block 920, logic and/or features of device 130 such as IO transaction logic 135 may cause an interrupt to be sent to a GPU driver to suggest GDDR reconfiguration for a use of at least a portion of GDDR capacity for system memory. In some examples, IO transaction logic 135 may use CXL.io protocols to send the interrupt. The suggested reconfiguration may partition a portion of device memory 134's GDDR memory capacity for use in system memory.

Moving from block 915 to decision block 920, the GPU driver decides whether to approve the suggested reconfiguration of GDDR capacity for system memory. If the GPU driver approves the change, logic flow 900 moves to block 925. If not approved, logic flow 900 moves to block 990.

Moving from decision block 920 to block 925, the GPU driver informs the device 130 to reconfigure GDDR capacity. In some examples, the GPU driver may use CXL.io protocols to inform IO transaction logic 135 of the approved reconfiguration.

Moving from block 925 to block 930, logic and/or features of device 130 such as memory transaction logic 134 and memory controller 131 reconfigures the GDDR capacity included in device memory 134 to expose a portion of the GDDR capacity as available CXL.mem for use in system memory.

Moving from block 930 to block 935, logic and/or features of device 130 such as memory transaction logic 133 reports new memory capacity to host OS 102. According to some examples, memory transaction logic 133 may use CXL.mem protocols to report the new memory capacity. The report to include a DPA range for the portion of GDDR capacity that is available for use in system memory.

Moving from block 930 to block 935, host OS 102 accepts the DPA range for the portion of GDDR capacity indicated as available for use in system memory. Logic flow 900 may then move to block 990, where logic and/or features of device 130 waits time (t) to reassess GPU utilization. Time (t) may be a few seconds, minutes or longer.

Moving from decision block 905 to block 945, GPU utilization indicates it would benefit from more GDDR capacity.

Moving from block 945 to block 950, logic and/or features of device 130 such as memory transaction logic 134 may send an interrupt to CXL.mem driver. In some examples, device driver(s) 104 of host OS 102 may include CXL.mem driver to control or manage memory capacity included in system memory.

Moving from block 950 to block 955, the CXL.mem driver informs host OS 102 of request to reclaim CXL.mem range. According to some examples, the CXL.mem range may include a DPA range exposed to host OS 102 by device 130 that includes a portion of GDDR capacity of device memory 134.

Moving from block 955 to decision block 960, host OS 102 internally decides if the CXL.mem range is able to be reclaimed. In some examples, current usage of system memory may have an unacceptable impact on system performance if the total memory capacity of system memory was reduced. For these examples, host OS 102 rejects the request and logic flow 900 moves to block 985 and host OS 102 informs device 130 that the request to reclaim its memory device capacity has been denied or indicate that the DPA range exposed cannot be removed form system memory. Logic flow 900 may then move to block 990, where logic and/or features of device 130 waits time (t) to reassess GPU utilization. If little to no impact to system performance, host OS 102 may accept the request and logic flow 900 moves to block 965.

Moving from decision block 960 to block 965, host OS 102 moves data out of the CXL.mem range included in the reclaimed GDDR capacity.

Moving from block 965 to block 970, host OS 102 informs device 130 when the data move is complete.

Moving from block 970 to block 975, device 130 removes the DPA ranges for the partition of device memory 134 previously exposed as CXL.mem range and dedicates the reclaim GDDR capacity for use by the GPU at device 130.

Moving from block 975 to block 980, logic and/or features of device 130 such as IO transaction logic 135 may inform the GPU driver of host OS 102 that increased memory capabilities now exist for use by the GPU at device 130. Logic flow 900 may then move to block 990, where logic and/or features of device 130 waits time (t) to reassess GPU utilization.

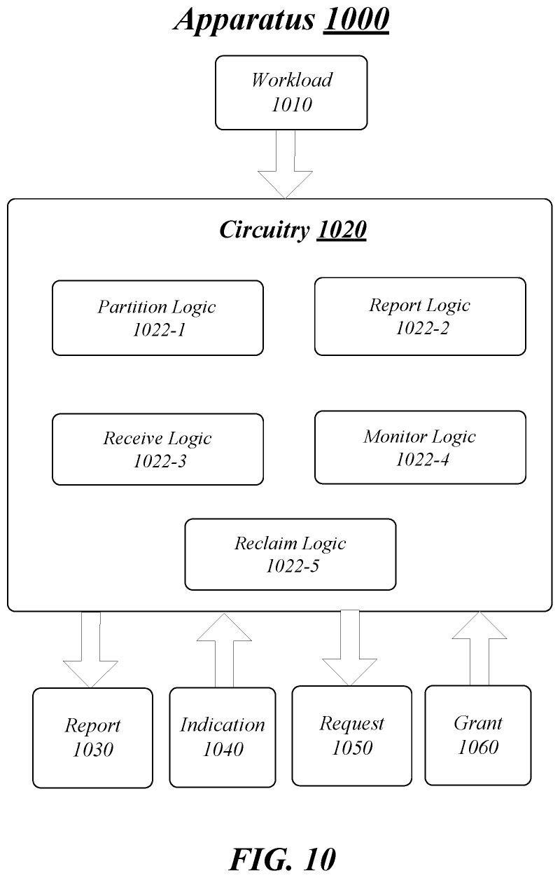

FIG. 10 illustrates an example apparatus 1000. Although apparatus 1000 shown in FIG. 10 has a limited number of elements in a certain topology, it may be appreciated that the apparatus 1000 may include more or less elements in alternate topologies as desired for a given implementation.

According to some examples, apparatus 1000 may be supported by circuitry 1020 and apparatus 1000 may be located as part of circuitry (e.g., host adaptor circuitry 132) of a device coupled with a host device (e.g., via CXL transaction links). Circuitry 1020 may be arranged to execute one or more software or firmware implemented logic, components, agents, or modules 1022-a (e.g., implemented, at least in part, by a controller of a memory device). It is worthy to note that “a” and “b” and “c” and similar designators as used herein are intended to be variables representing any positive integer. Thus, for example, if an implementation sets a value for a=5, then a complete set of software or firmware for logic, components, agents, or modules 1022-a may include logic 1022-1, 1022-2, 1022-3, 1022-4 or 1022-5. Also, at least a portion of “logic” may be software/firmware stored in computer-readable media, or may be implemented, at least in part in hardware and although the logic is shown in FIG. 10 as discrete boxes, this does not limit logic to storage in distinct computer-readable media components (e.g., a separate memory, etc.) or implementation by distinct hardware components (e.g., separate processors, processor circuits, cores, ASICs or FPGAs).

In some examples, apparatus 1000 may include a partition logic 1022-1. Partition logic 1022-1 may be a logic and/or feature executed by circuitry 1020 to partition a first portion of memory capacity of a memory configured for use by compute circuitry resident at the device that includes apparatus 1000, the compute circuitry to execute a workload, the first portion of memory capacity having a DPA range. For these examples, the workload may be included in workload 1010.

According to some examples, apparatus 1000 may include a report logic 1022-2. Report logic 1022-1 may be a logic and/or feature executed by circuitry 1020 to report to the host device that the first portion of memory capacity of the memory having the DPA range is available for use as a portion of pooled system memory managed by the host device. For these examples, report 1030 may include the report to the host device.

In some examples, apparatus 1000 may include a receive logic 1022-3. Receive logic 1022-3 may be a logic and/or feature executed by circuitry 1020 to receive an indication from the host device that the first portion of memory capacity of the memory having the DPA range has been identified for use as a first portion of pooled system memory. For these examples, indication 1040 may include the indication from the host device.

According to some examples, apparatus 1000 may include a monitor logic 1022-4. Monitor logic 1022-4 may be a logic and/or feature executed by circuitry 1020 to monitor memory usage of the memory configured for use by the compute circuitry resident at the device to determine whether the first portion of memory capacity is needed for the compute circuitry to execute the workload.

In some examples, apparatus 1000 may include a reclaim logic 1022-5. Reclaim logic 1022-5 may be a logic and/or feature executed by circuitry 1020 to cause a request to be sent to the host device, the request to reclaim the first portion of memory capacity having the DPA range from being used as the first portion based on a determination that the first portion of memory capacity is needed. For these examples, request 1050 includes the request to reclaim the first portion of memory capacity and grant 1060 indicates that the host device has approved the request. Partition logic 1022-1 may then remove, responsive to approval of the request, the partition of the first portion of memory capacity of the memory configured for use by the compute circuitry such that the compute circuitry is able to use all the memory capacity of the memory to execute the workload.

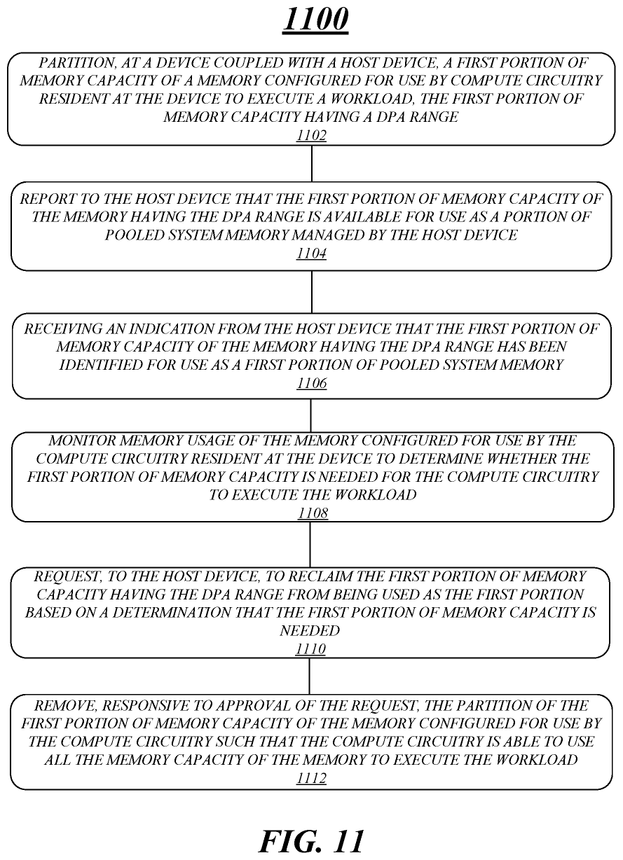

FIG. 11 illustrates an example of a logic flow 1100. Logic flow 1100 may be representative of some or all of the operations executed by one or more logic, features, or devices described herein, such as logic and/or features included in apparatus 1000. More particularly, logic flow 1100 may be implemented by one or more of partition logic 1022-1, report logic 1022-2, receive logic 1022-3, monitor logic 1022-4 or reclaim logic 1022-5.

According to some examples, as shown in FIG. 11, logic flow 1100 at block 1102 may partition, at a device coupled with a host device, a first portion of memory capacity of a memory configured for use by compute circuitry resident at the device to execute a workload, the first portion of memory capacity having a DPA range. For these example, partition logic 1022-1 may partition the first port of memory capacity.

In some examples, logic flow 1100 at block 1104 may report to the host device that the first portion of memory capacity of the memory having the DPA range is available for use as a portion of pooled system memory managed by the host device. For these examples, report logic 1022-2 may report to the host device.

According to some examples, logic flow 1100 at block 1106 may receive an indication from the host device that the first portion of memory capacity of the memory having the DPA range has been identified for use as a first portion of pooled system memory. For these examples, receive logic 1022-3 may receive the indication from the host device.

According to some examples, logic flow 1100 at block 1108 may monitor memory usage of the memory configured for use by the compute circuitry resident at the device to determine whether the first portion of memory capacity is needed for the compute circuitry to execute the workload. For these examples, monitor logic 1022-4 may monitor memory usage.

In some examples, logic flow 1100 at block 1110 may request, to the host device, to reclaim the first portion of memory capacity having the DPA range from being used as the first portion based on a determination that the first portion of memory capacity is needed. For these example, reclaim logic 1022-5 may send the request to the host device to reclaim the first portion of memory capacity.

According to some examples, logic flow 1100 at block 1112 may remove, responsive to approval of the request, the partition of the first portion of memory capacity of the memory configured for use by the compute circuitry such that the compute circuitry is able to use all the memory capacity of the memory to execute the workload. For these example, partition logic 1022-1 may remove the partition of the first portion of memory capacity.

The set of logic flows shown in FIGS. 9 and 11 may be representative of example methodologies for performing novel aspects described in this disclosure. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

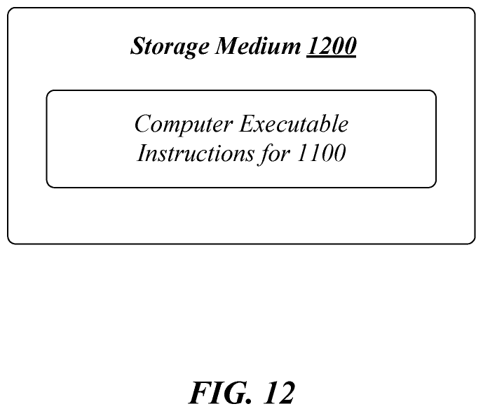

FIG. 12 illustrates an example of a storage medium. As shown in FIG. 12, the storage medium includes a storage medium 1200. The storage medium 1200 may comprise an article of manufacture. In some examples, storage medium 1200 may include any non-transitory computer readable medium or machine readable medium, such as an optical, magnetic or semiconductor storage. Storage medium 1200 may store various types of computer executable instructions, such as instructions to implement logic flow 1100. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

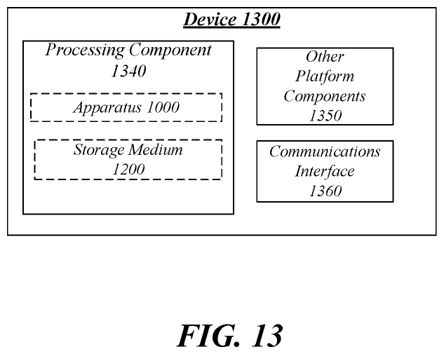

FIG. 13 illustrates an example device 1300. In some examples, as shown in FIG. 13, device 1300 may include a processing component 1340, other platform components 1350 or a communications interface 1360.

According to some examples, processing components 1340 may execute at least some processing operations or logic for apparatus 1000 based on instructions included in a storage media that includes storage medium 1200. Processing components 1340 may include various hardware elements, software elements, or a combination of both. For these examples, Examples of hardware elements may include devices, logic devices, components, processors, microprocessors, management controllers, companion dice, circuits, processor circuits, circuit elements (e.g., transistors, resistors, capacitors, inductors, and so forth), integrated circuits, ASICs, programmable logic devices (PLDs), digital signal processors (DSPs), FPGAs, memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (APIs), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

According to some examples, processing component 1340 may include an infrastructure processing unit (IPU) or a data processing unit (DPU) or may be utilized by an IPU or a DPU. An xPU may refer at least to an IPU, DPU, graphic processing unit (GPU), general-purpose GPU (GPGPU). An IPU or DPU may include a network interface with one or more programmable or fixed function processors to perform offload of workloads or operations that could have been performed by a CPU. The IPU or DPU can include one or more memory devices (not shown). In some examples, the IPU or DPU can perform virtual switch operations, manage storage transactions (e.g., compression, cryptography, virtualization), and manage operations performed on other IPUs, DPUs, servers, or devices.

In some examples, other platform components 1350 may include common computing elements, memory units (that include system memory), chipsets, controllers, peripherals, interfaces, oscillators, timing devices, video cards, audio cards, multimedia input/output (I/O) components (e.g., digital displays), power supplies, and so forth. Examples of memory units or memory devices included in other platform components 1350 may include without limitation various types of computer readable and machine readable storage media in the form of one or more higher speed memory units, such as GDDR, DDR, HBM, read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 1360 may include logic and/or features to support a communication interface. For these examples, communications interface 1360 may include one or more communication interfaces that operate according to various communication protocols or standards to communicate over direct or network communication links. Direct communications may occur via use of communication protocols or standards described in one or more industry standards (including progenies and variants) such as those associated with the PCIe specification, the CXL specification, the NVMe specification or the I3C specification. Network communications may occur via use of communication protocols or standards such those described in one or more Ethernet standards promulgated by the Institute of Electrical and Electronics Engineers (IEEE). For example, one such Ethernet standard promulgated by IEEE may include, but is not limited to, IEEE 802.3-2018, Carrier sense Multiple access with Collision Detection (CSMA/CD) Access Method and Physical Layer Specifications, Published in August 2018 (hereinafter “IEEE 802.3 specification”). Network communication may also occur according to one or more OpenFlow specifications such as the OpenFlow Hardware Abstraction API Specification. Network communications may also occur according to one or more Infiniband Architecture specifications.

Device 1300 may be coupled to a computing device that may be, for example, user equipment, a computer, a personal computer (PC), a desktop computer, a laptop computer, a notebook computer, a netbook computer, a tablet, a smart phone, embedded electronics, a gaming console, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof.

Functions and/or specific configurations of device 1300 described herein, may be included, or omitted in various embodiments of device 1300, as suitably desired.

The components and features of device 1300 may be implemented using any combination of discrete circuitry, ASICs, logic gates and/or single chip architectures. Further, the features of device 1300 may be implemented using microcontrollers, programmable logic arrays and/or microprocessors or any combination of the foregoing where suitably appropriate. It is noted that hardware, firmware and/or software elements may be collectively or individually referred to herein as “logic”, “circuit” or “circuitry.”

It should be appreciated that the exemplary device 1300 shown in the block diagram of FIG. 13 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

Although not depicted, any system can include and use a power supply such as but not limited to a battery, AC-DC converter at least to receive alternating current and supply direct current, renewable energy source (e.g., solar power or motion based power), or the like.

One or more aspects of at least one example may be implemented by representative instructions stored on at least one machine-readable medium which represents various logic within a processor, processor circuit, ASIC, or FPGA which when read by a machine, computing device or system causes the machine, computing device or system to fabricate logic to perform the techniques described herein. Such representations may be stored on a tangible, machine readable medium and supplied to various customers or manufacturing facilities to load into the fabrication machines that actually make the processor, processor circuit, ASIC, or FPGA.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The following examples pertain to additional examples of technologies disclosed herein.

Example 1. An example apparatus may include circuitry at a device coupled with a host device. The circuitry may partition a first portion of memory capacity of a memory configured for use by compute circuitry resident at the device to execute a workload, the first portion of memory capacity having a DPA range. The circuitry may also report to the host device that the first portion of memory capacity of the memory having the DPA range is available for use as a portion of pooled system memory managed by the host device. The circuitry may also receive an indication from the host device that the first portion of memory capacity of the memory having the DPA range has been identified for use as a first portion of pooled system memory.

Example 2. The apparatus of example 1, a second portion of pooled system memory managed by the host device may include a physical memory address range for memory resident on or directly attached to the host device.

Example 3. The apparatus of example 2, the host device may direct non-paged memory allocations to the second portion of pooled system memory and may prevent non-paged memory allocations to the first portion of pooled system memory.

Example 4. The apparatus of example 2, the host device may cause a memory allocation mapped to physical memory addresses included in the first portion of pooled system memory to be given to an application hosted by the host device for the application to store data. For this example, responsive to the application requesting a lock on the memory allocation, the host device may cause the memory allocation to be remapped to physical memory addresses included in the second portion of pooled system memory and may cause data stored to the physical memory addresses include in the first portion to be copied to the physical memory addresses included in the second portion.

Example 5. The apparatus of example 2, the circuitry may also monitor memory usage of the memory configured for use by the compute circuitry resident at the device to determine whether the first portion of memory capacity is needed for the compute circuitry to execute the workload. The circuitry may also cause a request to be sent to the host device, the request to reclaim the first portion of memory capacity having the DPA range from being used as the first portion based on a determination that the first portion of memory capacity is needed. The circuitry may also remove, responsive to approval of the request, the partition of the first portion of memory capacity of the memory configured for use by the compute circuitry such that the compute circuitry is able to use all the memory capacity of the memory to execute the workload.

Example 6. The apparatus of example 1, the device may be coupled with the host device via one or more CXL transaction links including a CXL.io transaction link or a CXL.mem transaction link.

Example 7. The apparatus of example 1, the compute circuitry may be a graphics processing unit and the workload may be a graphics processing workload.

Example 8. The apparatus of example 1, the compute circuitry may include a field programmable gate array or an application specific integrated circuit and the workload may be an accelerator processing workload.

Example 9. An example method may include partitioning, at a device coupled with a host device, a first portion of memory capacity of a memory configured for use by compute circuitry resident at the device to execute a workload, the first portion of memory capacity having a DPA range. The method may also include reporting to the host device that the first portion of memory capacity of the memory having the DPA range is available for use as a portion of pooled system memory managed by the host device. The method may also include receiving an indication from the host device that the first portion of memory capacity of the memory having the DPA range has been identified for use as a first portion of pooled system memory.

Example 10. The method of example 9, a second portion of pooled system memory may be managed by the host device that includes a physical memory address range for memory resident on or directly attached to the host device.

Example 11. The method of example 10, the host device may direct non-paged memory allocations to the second portion of pooled system memory and may prevent non-paged memory allocations to the first portion of pooled system memory.

Example 12. The method of example 10, the host device may cause a memory allocation mapped to physical memory addresses included in the first portion of pooled system memory to be given to an application hosted by the host device for the application to store data. For this example, responsive to the application requesting a lock on the memory allocation, the host device may cause the memory allocation to be remapped to physical memory addresses included in the second portion of pooled system memory and to cause data stored to the physical memory addresses include in the first portion to be copied to the physical memory addresses included in the second portion.

Example 13. The method of example 10 may also include monitoring memory usage of the memory configured for use by the compute circuitry resident at the device to determine whether the first portion of memory capacity is needed for the compute circuitry to execute the workload. The method may also include requesting, to the host device, to reclaim the first portion of memory capacity having the DPA range from being used as the first portion based on a determination that the first portion of memory capacity is needed. The method may also include removing, responsive to approval of the request, the partition of the first portion of memory capacity of the memory configured for use by the compute circuitry such that the compute circuitry is able to use all the memory capacity of the memory to execute the workload.

Example 14. The method of example 9, the device may be coupled with the host device via one or more CXL transaction links including a CXL.io transaction link or a CXL.mem transaction link.

Example 15. The method of example 9, the compute circuitry may be a graphics processing unit and the workload may be a graphics processing workload.

Example 16. The method of example 9, the compute circuitry may be a field programmable gate array or an application specific integrated circuit and the workload may be an accelerator processing workload.

Example 17. An example at least one machine readable medium may include a plurality of instructions that in response to being executed by a system may cause the system to carry out a method according to any one of examples 9 to 16.

Example 18. An example apparatus may include means for performing the methods of any one of examples 9 to 16.

Example 19. An example at least one non-transitory computer-readable storage medium may include a plurality of instructions, that when executed, cause circuitry to partition, at a device coupled with a host device, a first portion of memory capacity of a memory configured for use by compute circuitry resident at the device to execute a workload, the first portion of memory capacity having a DPA range. The instructions may also cause the circuitry to report to the host device that the first portion of memory capacity of the memory having the DPA range is available for use as a portion of pooled system memory managed by the host device. The instructions may also cause the circuitry to receive an indication from the host device that the first portion of memory capacity of the memory having the DPA range has been identified for use as a first portion of pooled system memory.

Example 20. The least one non-transitory computer-readable storage medium of example 19, a second portion of pooled system memory may be managed by the host device that includes a physical memory address range for memory resident on or directly attached to the host device.

Example 21. The least one non-transitory computer-readable storage medium of example 20, the host device may direct non-paged memory allocations to the second portion of pooled system memory and may prevent non-paged memory allocations to the first portion of pooled system memory.

Example 22. The least one non-transitory computer-readable storage medium of example 20, the host device may cause a memory allocation mapped to physical memory addresses included in the first portion of pooled system memory to be given to an application hosted by the host device for the application to store data. For this example, responsive to the application requesting a lock on the memory allocation, the host device may cause the memory allocation to be remapped to physical memory addresses included in the second portion of pooled system memory and to cause data stored to the physical memory addresses include in the first portion to be copied to the physical memory addresses included in the second portion.

Example 23. The least one non-transitory computer-readable storage medium of example 20, the instructions may also cause the circuitry to monitor memory usage of the memory configured for use by the compute circuitry resident at the device to determine whether the first portion of memory capacity is needed for the compute circuitry to execute the workload. The instructions may also cause the circuitry to request, to the host device, to reclaim the first portion of memory capacity having the DPA range from being used as the first portion based on a determination that the first portion of memory capacity is needed. The instructions may also cause the circuitry to remove, responsive to approval of the request, the partition of the first portion of memory capacity of the memory configured for use by the compute circuitry such that the compute circuitry is able to use all the memory capacity of the memory to execute the workload.

Example 24. The least one non-transitory computer-readable storage medium of example 19, the device may be coupled with the host device via one or more CXL transaction links including a CXL.io transaction link or a CXL.mem transaction link.

Example 25. The least one non-transitory computer-readable storage medium of example 19, the compute circuitry may be a graphics processing unit and the workload may be a graphics processing workload.

Example 26. The least one non-transitory computer-readable storage medium of example 19, the compute circuitry may be a field programmable gate array or an application specific integrated circuit and the workload may be an accelerator processing workload.

Example 27. An example device may include compute circuitry to execute a workload. The device may also include a memory configured for use by the compute circuitry to execute the workload. The device may also include host adaptor circuitry to couple with a host device via one or more CXL transaction links, the host adaptor circuitry to partition a first portion of memory capacity of the memory having a DPA range. The host adaptor circuitry may also report, via the one or more CXL transaction links, that the first portion of memory capacity of the memory having the DPA range is available for use as a portion of pooled system memory managed by the host device. The host adaptor circuitry may also receive, via the one or more CXL transaction links, an indication from the host device that the first portion of memory capacity of the memory having the DPA range has been identified for use as a first portion of pooled system memory.

Example 28. The device of example 27, a second portion of pooled system memory may be managed by the host device includes a physical memory address range for memory resident on or directly attached to the host device.

Example 29. The device of example 28, the host device may direct non-paged memory allocations to the second portion of pooled system memory and may prevent non-paged memory allocations to the first portion of pooled system memory.

Example 30. The device of example 28, the host device may cause a memory allocation mapped to physical memory addresses included in the first portion of pooled system memory to be given to an application hosted by the host device for the application to store data. For this example, responsive to the application requesting a lock on the memory allocation, the host device may cause the memory allocation to be remapped to physical memory addresses included in the second portion of pooled system memory and may cause data stored to the physical memory addresses include in the first portion to be copied to the physical memory addresses included in the second portion.

Example 31. The device of example 28, the host adaptor circuitry may also monitor memory usage of the memory configured for use by the compute circuitry to determine whether the first portion of memory capacity is needed for the compute circuitry to execute the workload. The host adaptor circuitry may also cause a request to be sent to the host device via the one or more CXL transaction links, the request to reclaim the first portion of memory capacity having the DPA range from being used as the first portion based on a determination that the first portion of memory capacity is needed. The host adaptor circuitry may also remove, responsive to approval of the request, the partition of the first portion of memory capacity of the memory configured for use by the compute circuitry such that the compute circuitry is able to use all the memory capacity of the memory to execute the workload.

Example 32. The device of example 27, the one or more CXL transaction links may include a CXL.io transaction link or a CXL.mem transaction link.

Example 33. The device of example 27, the compute circuitry may be a graphics processing unit and the workload may be a graphics processing workload.

Example 34. The device of example 27, the compute circuitry may be a field programmable gate array or an application specific integrated circuit and the workload may be an accelerator processing workload.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
circuitry at a device coupled with a host device, the circuitry to:
partition a first portion of memory capacity of a memory configured for use by compute circuitry resident at the device to execute a workload, the first portion of memory capacity having a device physical address (DPA) range;
report to the host device that the first portion of memory capacity of the memory having the DPA range is available for use as a portion of pooled system memory managed by the host device; and
receive an indication from the host device that the first portion of memory capacity of the memory having the DPA range has been identified for use as a first portion of pooled system memory.

2. The apparatus of claim 1, wherein a second portion of pooled system memory managed by the host device includes a physical memory address range for memory resident on or directly attached to the host device.

3. The apparatus of claim 2, wherein the host device directs non-paged memory allocations to the second portion of pooled system memory and prevents non-paged memory allocations to the first portion of pooled system memory.

4. The apparatus of claim 2, comprising the host device to cause a memory allocation mapped to physical memory addresses included in the first portion of pooled system memory to be given to an application hosted by the host device for the application to store data, wherein responsive to the application requesting a lock on the memory allocation, the host device is to cause the memory allocation to be remapped to physical memory addresses included in the second portion of pooled system memory and to cause data stored to the physical memory addresses include in the first portion to be copied to the physical memory addresses included in the second portion.

5. The apparatus of claim 2, further comprising the circuitry to:
monitor memory usage of the memory configured for use by the compute circuitry resident at the device to determine whether the first portion of memory capacity is needed for the compute circuitry to execute the workload;
cause a request to be sent to the host device, the request to reclaim the first portion of memory capacity having the DPA range from being used as the first portion based on a determination that the first portion of memory capacity is needed; and
remove, responsive to approval of the request, the partition of the first portion of memory capacity of the memory configured for use by the compute circuitry such that the compute circuitry is able to use all the memory capacity of the memory to execute the workload.

6. The apparatus of claim 1, comprising the device coupled with the host device via one or more Compute Express Link (CXL) transaction links including a CXL.io transaction link or a CXL.mem transaction link.

7. The apparatus of claim 1, the compute circuitry comprising a graphics processing unit, wherein the workload is a graphics processing workload.

8. The apparatus of claim 1, the compute circuitry comprising a field programmable gate array or an application specific integrated circuit, wherein the workload is an accelerator processing workload.

9. A method comprising:
partitioning, at a device coupled with a host device, a first portion of memory capacity of a memory configured for use by compute circuitry resident at the device to execute a workload, the first portion of memory capacity having a device physical address (DPA) range;
reporting to the host device that the first portion of memory capacity of the memory having the DPA range is available for use as a portion of pooled system memory managed by the host device; and
receiving an indication from the host device that the first portion of memory capacity of the memory having the DPA range has been identified for use as a first portion of pooled system memory.

10. The method of claim 9, wherein a second portion of pooled system memory managed by the host device includes a physical memory address range for memory resident on or directly attached to the host device.

11. The method of claim 10, wherein the host device directs non-paged memory allocations to the second portion of pooled system memory and prevents non-paged memory allocations to the first portion of pooled system memory.

12. The method of claim 10, comprising the host device to cause a memory allocation mapped to physical memory addresses included in the first portion of pooled system memory to be given to an application hosted by the host device for the application to store data, wherein responsive to the application requesting a lock on the memory allocation, the host device is to cause the memory allocation to be remapped to physical memory addresses included in the second portion of pooled system memory and to cause data stored to the physical memory addresses include in the first portion to be copied to the physical memory addresses included in the second portion.

13. The method of claim 10, further comprising:
monitoring memory usage of the memory configured for use by the compute circuitry resident at the device to determine whether the first portion of memory capacity is needed for the compute circuitry to execute the workload;
requesting, to the host device, to reclaim the first portion of memory capacity having the DPA range from being used as the first portion based on a determination that the first portion of memory capacity is needed; and
removing, responsive to approval of the request, the partition of the first portion of memory capacity of the memory configured for use by the compute circuitry such that the compute circuitry is able to use all the memory capacity of the memory to execute the workload.

14. The method of claim 9, comprising the device coupled with the host device via one or more Compute Express Link (CXL) transaction links including a CXL.io transaction link or a CXL.mem transaction link.

15. The method of claim 9, the compute circuitry comprising a graphics processing unit, wherein the workload is a graphics processing workload.

16. At least one non-transitory computer-readable storage medium, comprising a plurality of instructions, that when executed, cause circuitry to:
partition, at a device coupled with a host device, a first portion of memory capacity of a memory configured for use by compute circuitry resident at the device to execute a workload, the first portion of memory capacity having a device physical address (DPA) range;
report to the host device that the first portion of memory capacity of the memory having the DPA range is available for use as a portion of pooled system memory managed by the host device; and
receive an indication from the host device that the first portion of memory capacity of the memory having the DPA range has been identified for use as a first portion of pooled system memory.

17. The least one non-transitory computer-readable storage medium of claim 16, wherein a second portion of pooled system memory managed by the host device includes a physical memory address range for memory resident on or directly attached to the host device.

18. The least one non-transitory computer-readable storage medium of claim 17, wherein the host device directs non-paged memory allocations to the second portion of pooled system memory and prevents non-paged memory allocations to the first portion of pooled system memory.

19. The least one non-transitory computer-readable storage medium of claim 17, comprising the host device to cause a memory allocation mapped to physical memory addresses included in the first portion of pooled system memory to be given to an application hosted by the host device for the application to store data, wherein responsive to the application requesting a lock on the memory allocation, the host device is to cause the memory allocation to be remapped to physical memory addresses included in the second portion of pooled system memory and to cause data stored to the physical memory addresses include in the first portion to be copied to the physical memory addresses included in the second portion.

20. The least one non-transitory computer-readable storage medium of claim 17, further comprising the instructions to cause the circuitry to:
monitor memory usage of the memory configured for use by the compute circuitry resident at the device to determine whether the first portion of memory capacity is needed for the compute circuitry to execute the workload;
request, to the host device, to reclaim the first portion of memory capacity having the DPA range from being used as the first portion based on a determination that the first portion of memory capacity is needed; and
remove, responsive to approval of the request, the partition of the first portion of memory capacity of the memory configured for use by the compute circuitry such that the compute circuitry is able to use all the memory capacity of the memory to execute the workload.

21. The least one non-transitory computer-readable storage medium of claim 16, comprising the device coupled with the host device via one or more Compute Express Link (CXL) transaction links including a CXL.io transaction link or a CXL.mem transaction link.

22. The least one non-transitory computer-readable storage medium of claim 16, the compute circuitry comprising a field programmable gate array or an application specific integrated circuit, wherein the workload is an accelerator processing workload.

23. A device, comprising:
compute circuitry to execute a workload;
a memory configured for use by the compute circuitry to execute the workload; and
host adaptor circuitry to couple with a host device via one or more Compute Express Link (CXL) transaction links, the host adaptor circuitry to:
partition a first portion of memory capacity of the memory having a device physical address (DPA) range;
report, via the one or more CXL transaction links, that the first portion of memory capacity of the memory having the DPA range is available for use as a portion of pooled system memory managed by the host device; and
receive, via the one or more CXL transaction links, an indication from the host device that the first portion of memory capacity of the memory having the DPA range has been identified for use as a first portion of pooled system memory.

24. The device of claim 23, wherein a second portion of pooled system memory managed by the host device includes a physical memory address range for memory resident on or directly attached to the host device.

25. The device of claim 24, wherein the host device directs non-paged memory allocations to the second portion of pooled system memory and prevents non-paged memory allocations to the first portion of pooled system memory.

26. The device of claim 24, comprising the host device to cause a memory allocation mapped to physical memory addresses included in the first portion of pooled system memory to be given to an application hosted by the host device for the application to store data, wherein responsive to the application requesting a lock on the memory allocation, the host device is to cause the memory allocation to be remapped to physical memory addresses included in the second portion of pooled system memory and to cause data stored to the physical memory addresses include in the first portion to be copied to the physical memory addresses included in the second portion.

27. The device of claim 24, further comprising the host adaptor circuitry to:
monitor memory usage of the memory configured for use by the compute circuitry to determine whether the first portion of memory capacity is needed for the compute circuitry to execute the workload;
cause a request to be sent to the host device via the one or more CXL transaction links, the request to reclaim the first portion of memory capacity having the DPA range from being used as the first portion based on a determination that the first portion of memory capacity is needed; and
remove, responsive to approval of the request, the partition of the first portion of memory capacity of the memory configured for use by the compute circuitry such that the compute circuitry is able to use all the memory capacity of the memory to execute the workload.

28. The device of claim 23, comprising the one or more CXL transaction links including a CXL.io transaction link or a CXL.mem transaction link.

29. The device of claim 23, the compute circuitry comprising a graphics processing unit, wherein the workload is a graphics processing workload.

30. The device of claim 23, the compute circuitry comprising a field programmable gate array or an application specific integrated circuit, wherein the workload is an accelerator processing workload.
